(19) United States
(12) Patent Application Publication
(10) Pub. No.: US 2020/0188856 A1
(43) Pub. Date: Jun. 18, 2020

(54) MONITOR FOR DIFFUSIOPHORETIC WATER FILTRATION DEVICE AND RELATED METHOD

(71) Applicant: Split Rock Filter Systems LLC, New Paltz, NY (US)

(72) Inventor: William C. Gehris, New Paltz, NY (US)

(21) Appl. No.: 16/714,734

(22) Filed: Dec. 14, 2019

Related U.S. Application Data
(60) Provisional application No. 62/779,947, filed on Dec. 14, 2018.
(60) Provisional application No. 62/780,315, filed on Dec. 16, 2018.

(51) Int. Cl. B01D 65/10; C02F 1/44; G01N 15/06

(52) U.S. Cl. CPC B01D 65/104; C02F 1/44; B01D 71/68; C02F 2209/00; G01N 15/06

(57) ABSTRACT

A diffusiophoretic water filter has a monitor for monitoring for leaks, blockages or efficiency. Methods are also provided.

This claims the benefit of U.S. Provisional Patent Application No. 62/779,947, filed Dec. 14, 2018 and 62/780,315, filed Dec. 16, 2018, both of which are hereby incorporated by reference herein.

### BACKGROUND

The article “Diffusiophoretic exclusion of colloidal particles for continuous water purification” by Lee et al. (Lab on a Chip 2018, 18, 1713), 21 Jun. 2018, describes using two sheets of a NAFION membrane aligned on a glass slide to perform diffusiophoretic exclusion.

WO 2018/048735 discloses a device operative in separating particles in a flowing suspension of the particles in a liquid which device comprises: a first, pressurized cavity or plenum adapted to contain a gas, separated by a first gas permeable wall from a second cavity or plenum which contains a charged particle containing liquid which also contains an ion species formed by the dissolution of the gas within the liquid, which is in turn separated by a second permeable wall from the ambient atmosphere or an optional, third, relatively reduced pressure cavity or plenum which may contain a gas or a vacuum; wherein: the permeable walls operate to permit for the transfer of a gas from the first cavity through the second cavity and through the second permeable wall to the atmosphere or a third cavity and, the pressure present in atmosphere or the third cavity is lesser than that of the first cavity, thus forming an ion concentration differential within the liquid and between the permeable walls.

The related article “Membraneless water filtration using CO2” by Shin et al. (Nature Communications 8:15181), 2 May 2017, describes a continuous flow particle filtration device in which a colloidal suspension flows through a straight channel in a gas permeable material made of polydimethylsiloxane (PDMS). A CO2 (carbon dioxide) gas channel passes parallel to the wall and dissolves into the flow stream. An air channel on the other side of the wall prevents saturation of CO2 in the suspension and the resulting gradient of CO2 causes particles to concentrate on sides of the channel, with negatively charged particles moving toward the air channel and positively charged particles toward the CO2 channel. The water away from the sides of the channel can be collected as filtered water.

The article “Diffusiophoresis at the macroscale” by Mauger et al. (arXiv: 1512.05005v4), 6 Jul. 2016, discloses that solute concentration gradients caused by salts such as LiCl impact colloidal transport at lengthscales ranging roughly from the centimeter down to the smallest scales resolved by the article. Colloids of a diameter of 200nm were examined.

The article “Origins of concentration gradients for diffusiophoresis” by Velegol et al, (10.1039/c6sm00052e), 13 May 2016, describes diffusiophoresis possibly occurring in georeservoir extractions, physiological systems, drying operations, laboratory and industrial separations, crystallization operations, membrane processes, and many other situations, often without being recognized.

PCT Publication WO 2015/077674 discloses a process that places a microparticle including a salt in proximity to a membrane such that the microparticle creates a gradient generated spontaneous electric field or a gradient generated spontaneous chemiphoretic field in the solvent proximal to the membrane. This gradient actively draws charged particles, via diffusiophoresis, away from the membrane thereby removing charged particulate matter away from the membrane or preventing its deposition.

### SUMMARY OF THE INVENTION

For both gas driven and ion-exchange driven diffusiophoretic water filters, it can be advantageous to determine that the filter is working properly. In gas driven water filters, the ion exchange membrane can saturate with the exchange ion, such as sodium, and no longer function properly. Channels can also break or become clogged.

The present invention provides a water filtration device comprising a diffusiophoretic water filter having an inlet and an outlet and for receiving a colloidal suspension at the inlet and flowing the colloidal suspension between the inlet and the outlet in a flow direction; a diffusiophoretic-inducing membrane; a cover, the membrane and the cover defining a plurality of channels extending between the inlet and the outlet; at least one outlet splitter for the plurality of channels; and a channel monitor monitoring a flow of each of the plurality channels.

The present invention may contain one or more of the following additional features, alone or in combination with other features:

the channel monitor monitors the channel flow downstream of where the outlet splitter splits the channels;

the channel monitor is attached to a detachable outlet splitter;

the channel monitor monitors the presence or absence of water in each channel;

the channel monitor measures a marker in the colloidal suspension, the marker being an added or identified colloid or ion in the colloidal suspension;

the channel monitor extends into the waste stream of each channel in the outlet splitter;

the channel monitor measures an optical characteristic through a thickness of each channel;

the channel monitor measures a flow rate of the channel;

the channel monitor measures an electrical characteristic of each channel;

the channel monitor detects the presence of a gas used in a gas-driven diffusionphorteic water filter;

the channel monitor detects the presence of air;

a shutdown gate is provided for each channel;

the shutdown gate is at the inlet of the water filter;

a sealant injector is provided for each channel;

the sealant injector is at the inter of the water filter;

the sealant injects a silicone-based sealant.

The present invention also provides a method for operating a water filtration device comprising a diffusiophoretic water filter having an inlet and an outlet and for receiving a colloidal suspension at the inlet and flowing the colloidal suspension between the inlet and the outlet in a flow direction; a diffusiophoretic-inducing membrane; a cover, the membrane and the cover defining a plurality of channels extending between the inlet and the outlet; the method comprising monitoring each of the plurality of channels.

The monitoring may be a fault detection monitoring.

The present invention also provides a method of determining the efficacy of a diffusiophoretic water filter comprising:

adding a marker to a colloidal suspension with first colloidal particles to form a marked colloidal suspension;

diffusiophoretically filtering the marked colloidal suspension into a first stream with a higher concentration of the first colloidal particles and a second stream with a lower concentration of the first colloidal particles; and

monitoring the marker at an outlet.

The marker preferably is a visibly, either to the eye or with the aid of a device such as an infrared light, identifiable marker. The marker in one embodiment may be for example Ferrous oxide Fe2O3 (Iron III oxide) with a particle size of 50 nanometers or less. The marker thus preferably forms a marked colloidal particle in the colloidal suspension. The marked colloidal particle preferably has a same charge as the colloidal particles sought to be filtered, and a experiences a diffusiophoretic velocity within 25%, most preferably 10%, of the average diffusiophoretic velocity experienced by the first colloidal particles in the suspension.

The marker preferably is visible to the eye, so that for example the waste water in the first stream appears colored, for example rust-colored due to the iron oxide.

The marker preferably is nontoxic.

The marker preferably also may impart a taste to the water. Iron oxide as well can taste rusty, and if a higher concentration is found in the filtered water stream a user may taste the marker. The taste-sensitive marker need not be visible.

The monitoring thus preferably is a visible (including with the aid of a device) or taste-sensitive nontoxic marker.

The above embodiment can be used with both ion-driven diffusiophoretic water filters or gas driven diffusiophoretic water filters such as in U.S. Pat. No. 10,155,182. The marker can simply be added to the water to be filtered.

In ion-driven diffusiophoretic water filters however, the marker could for example be the salt added to drive the ion-exchange. A salt meter at the output then can determine for example that the salt concentration has risen in the filtered water to a certain level, and thus indicate that the ion-exchange membrane is exhausted and the filtration is no longer working properly. For example if being driven by a 1 mM concentration of salt, and the output water has a salt concentration during proper operation of 0.1 mM due to the ion exchange, if the filter starts outputting a salt concentration above a threshold of 0.25 mM, the filtration can be determined as no longer operating properly. The exact threshold can be determined as function of a desired efficacy for one or more particles to be filtered.

The present invention also provides a method of determining the efficacy of a diffusiophoretic water filter comprising:

identifying a marker in a colloidal suspension with first colloidal particles to form a marked colloidal suspension;

diffusiophoretically filtering the marked colloidal suspension into a first stream with a higher concentration of the first colloidal particles and a second stream with a lower concentration of the first colloidal particles; and

monitoring the marker at an outlet.

Again, the marker may for example be iron oxide if for example the water to be filtered is pond water that is rust-colored. As long as the filtered water runs clear, the efficacy of the water filter can be trusted, depending on the types of colloidal particles desired to be filtered. Particles having a similar diffusiophoretic velocity to the iron oxide thus can be identified.

The marker in an ion-driven device could for example be a salt concentration already present, or also iron oxide if present.

Salt has the advantage that accurate hand-held salt meters are readily available.

### BRIEF DESCRIPTION OF THE DRAWINGS

One schematic embodiment of the water filtration system of the present invention is shown by reference to FIG. 1 in which:

FIG. 1 shows the water filtration device of the present invention

FIG. 2 shows a flowchart of a method according to an embodiment of the present invention.

### DETAILED DESCRIPTION OF AN EMBODIMENT

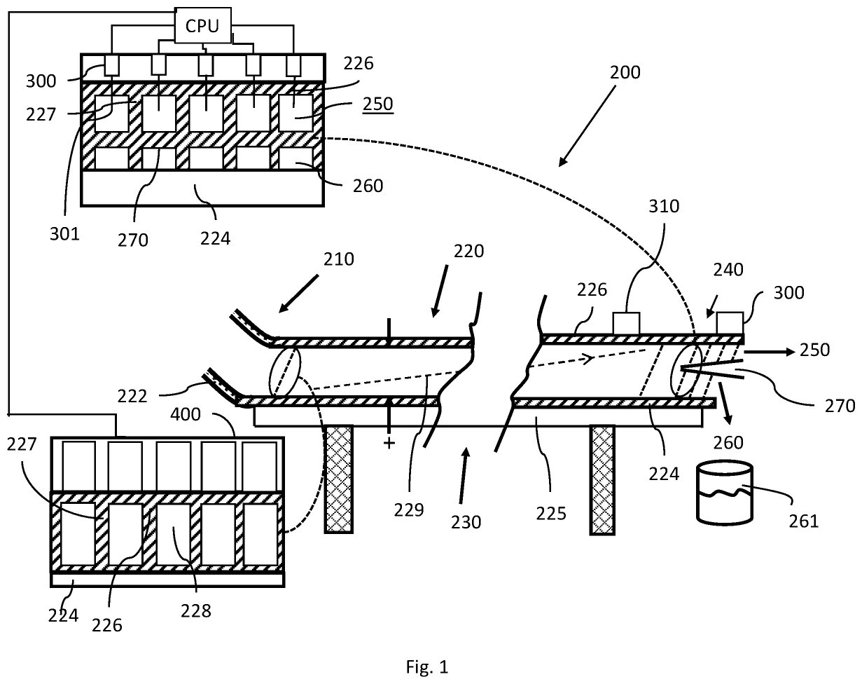

FIG. 1 shows a diffusiophoretic water filtration system 200 for cleaning river water, which may contain various particles such as colloidal plastic or metallic particles, and other bioparticles such as bacteria and viruses. Many of these particles are charged negatively or positively. Any type of water with charged colloidal particles may be filtered using the present invention. “Colloidal particle” as defined herein is any particle that can form a colloid or colloidal suspension in water. Such colloidal particles typically range in sizes of a micrometer or less, but larger sizes are possible. The present invention is not limited to filtering colloidal particles, but can also be used to filter larger particles that are impacted by diffusiophoresis, for example even up to 100 nanometers in size or larger, from water. Preferably the particles to be filtered are less than 250 nanometers in size, even if not colloidal.

Water can be taken by taking water from a river or pond or other source, and may go through a sand filter or other preliminary filtration device.

Portable water filtration device 200 is designed to remove negatively charged colloidal particles and other particles, the removal of which can significantly increase the water quality.

Water filtration device 200, shown schematically, can include a diffusiophoretic water filter 220 and an inlet manifold 210. An outlet section 240 splits the colloidal suspension into water passing into a filtered water outlet 260 to fall into a glass or other container 261. Waste water can exit waste water outlet 250.

Water filtration device 200 has an inlet manifold 210 receiving water with colloidal particles and may be partly defined by an upstream extension 222 of diffusiophoretic water filter 220. The extension 222 may be a PDMS membrane integral with or connected to a membrane cover and used to create an active section 230 of the water filter 220. Inlet manifold 210 thus spreads the water with colloidal particles in the widthwise direction into the active section 230. In this example the water with colloidal particles is spread in the inlet manifold to a width of 12 cm, and is maintained generally at a depth of 50 cm, which height thus regulates the pressure of the suspension that flows into the active section 230. Larger heights can provide larger pressures, and thus faster velocities through the active section 230.

Alternate to the design above, a flexible or solid triangular-shaped manifold diffuser can connect the pipe to the active section 230, which permits wider active sections 230 to be used with smaller diameter pipes. Wider active sections of 50 cm to 150 cm or even larger may be preferred for larger filter throughputs for example.

As shown in FIG. 1, the inlet manifold extension 222 connects with an active section 230 of the water filter 220. In this embodiment, a thin ion-exchange membrane such as a PDMS 30 micrometer thick membrane commercially available from SSP in Ballston Spa, N.Y. can be used as a diffusiophoretic-inducing membrane 224, together with a gas chamber 225, to impart a diffusiophoretic action on the water filter 220. However, ion exchange membranes such as NAFION can also be used.

The membrane 224 is connected to a top cover 226 made for example of PDMS or other expandable material. The cover preferably has ridges 227 that are sealed with respect to membrane 224 to form a channel structure of side-by-side elongated channels in the active section 230. The cover and membrane may be integral and formed for example by soft lithography of PDMS material. Thousands of channels, for example each 100 micrometers by 100 micrometers, can be created, and monitored by the present invention.

As water containing colloidal particles enters active section 230, negatively-charged colloidal particles 229 move away from membrane 224 due to diffusiophoresis. The negatively-charged colloidal particles are exited with waste water at exit 250, and may include bacteria, viruses and other negatively-charged colloidal particles. Filtered water, split from the waste water by a splitter 270 exits at filtered water exit 260, for example into a cup 261.

FIG. 3 shows schematically the movement of colloidal particles 229 away from membrane 224 and toward outlet 250. As shown by the cross-sectional cutouts, cover 226 with its ridges 227, and membrane 224 defines channels 228 at the inlet, while at the outlet outlet splitter 270 divides the channels into waste outlet 250 and filtered water outlet 260. Water can exit outlet 260 simply via gravity.

Splitter 270 can be manufactured integrally out of PDMS material for example as described above, and be for example 10 micrometers thick at its leading edge and, while not necessary, then thicken to be V-shaped. However, splitter 270 also could be for example a metal blade, for example with cross sectional dimensions similar to a razor blade described in U.S. Patent Application No. 2018/0043561, but with a width for all channels.

With 5 channels each 2 cm wide and 300 micrometers thick, an active section length of 1 m, and a water height of about 40 cm and a splitter ratio of 50/50, the water filter 220 can process approximately 1.4 ml/s of water, 0.7 ml/s of which is clean, providing a clean water capacity of 42 ml/min or 2.5 1/hr. The velocity through the device is approximately 0.044 m/s, which gives a dwell time of 23 seconds, which can allow for sufficient diffusiophoretic movement of colloidal particles. Depending on the type of particles to be filtered and the desired concentration of colloidal particles, lower capacity and speeds can be easily provided by using lower water heights. Longer active length sections could also be provided without decreasing capacity.

Monitor 300 preferably sits over the outlet splitter section 240 (which can be removable from active section 230) and includes probes 301 that can individually monitor for example the presence of waste water, the flow velocity of the waste water, or the presence and amount of certain markers. For example iron oxide colloidal nanoparticles, which are nontoxic and colored and magnetic, can be easily sensed. A concentration of these particles at the inlet can be determined or provided (for example by the user) and measured by probe 301. Probe 301 also could be a microfluidic flow sensor, for example as available from Elveflow. More than one probe measuring varying characteristics could be provided for each channel, and the data input to a CPU. The presence of the probes downstream of the splitter, and especially in the waste stream 250, can be highly advantageous, as any disruptive effects of the probe on laminar flow or the diffusiophoretic action are no longer an issue. Probes 301 also could be used to detect the absence of water, indicating a channel failure, and or measure for CO2, indicating leak though membrane 224 into the channel.

Probe 301 also could be used to monitor more than one channel, for example further downstream as the channels combine. For example, five waste channels could combine and a single probe used to monitor 5 channels. A hundred channel water filter thus could be monitored in 20 sections by 20 probes.

While monitor 300 preferably is downstream from the water splitting, a monitor 210 providing for example optical monitoring, for example through a clear PDMS cover 226, could be used to monitor the channels alternately or additionally, and to monitor each channel for example with an individual laser or LED.

The information from each channel can be used for example to impact a gate array 400 at the inlet 210. Gate array 400 could be used for example to stop flow by shutting a gate over the inlet of one channel 228 if a channel was found to be blocked or not functioning properly. If for example a leak is coming from the gas chamber, an injection device also at the inlet could be activated to block the channel with a sealant. The CPU can also display the status of each channel via a GUI.

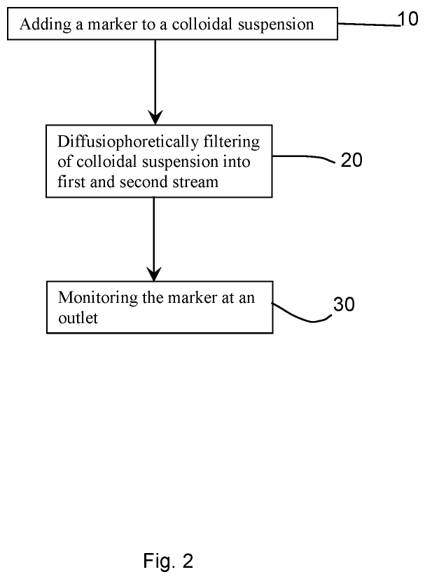

FIG. 2 shows a method of determining the efficacy of a diffusiophoretic water filter. At step 10, a marker is added to a colloidal suspension with first colloidal particles to form a marked colloidal suspension. Step 20 shows diffusiophoretically filtering the marked colloidal suspension into a first stream with a higher concentration of the first colloidal particles and a second stream with a lower concentration of the first colloidal particles; and step 30 show monitoring the marker at an outlet.

The marker preferably is a visibly, either to the eye or with the aid of a device such as an infrared light, identifiable marker. The marker in one embodiment may be for example Ferrous oxide Fe2O3 (Iron III oxide) with a particle size of 50 nanometers or less. The marker thus preferably forms a marked colloidal particle in the colloidal suspension. The marked colloidal particle preferably has a same charge as the colloidal particles sought to be filtered, and a experiences a diffusiophoretic velocity within 25%, most preferably 10%, of the average diffusiophoretic velocity experienced by the first colloidal particles in the suspension.

The marker preferably is visible to the eye, so that for example the waste water in the first stream appears colored, for example rust-colored due to the iron oxide.

The marker preferably is nontoxic.

The marker preferably also may impart a taste to the water. Iron oxide as well can taste rusty, and if a higher concentration is found in the filtered water stream a user may taste the marker. The taste-sensitive marker need not be visible.

The monitoring thus preferably is a visible (including with the aid of a device) or taste-sensitive nontoxic marker.

The above embodiment can be used with both ion-driven diffusiophoretic water filters or gas driven diffusiophoretic water filters such as in U.S. Pat. No. 10,155,182. The marker can simply be added to the water to be filtered.

In ion-driven diffusiophoretic water filters however, the marker could for example be the salt added to drive the ion-exchange. A salt meter at the output then can determine for example that the salt concentration has risen in the filtered water to a certain level, and thus indicate that the ion-exchange membrane is exhausted and the filtration is no longer working properly. For example if being driven by a 1 mM concentration of salt, and the output water has a salt concentration during proper operation of 0.1 mM due to the ion exchange, if the filter starts outputting a salt concentration above a threshold of 0.25 mM, the filtration can be determined as no longer operating properly. The exact threshold can be determined as function of a desired efficacy for one or more particles to be filtered.

A further embodiment comprises a method of determining the efficacy of a diffusiophoretic water filter comprising:

identifying a marker in a colloidal suspension with first colloidal particles to form a marked colloidal suspension;

diffusiophoretically filtering the marked colloidal suspension into a first stream with a higher concentration of the first colloidal particles and a second stream with a lower concentration of the first colloidal particles; and

monitoring the marker at an outlet.

Again, the marker may for example be iron oxide if for example the water to be filtered is pond water that is rust-colored. As long as the filtered water runs clear, the efficacy of the water filter can be trusted, depending on the types of colloidal particles desired to be filtered. Particles having a similar diffusiophoretic velocity to the iron oxide thus can be identified.

The marker in an ion-driven device could for example be a salt concentration already present, or also iron oxide if present.

Salt has the advantage that accurate hand-held salt meters are readily available.

What is claimed is:

1. A water filtration device comprising a diffusiophoretic water filter having an inlet and an outlet and for receiving a colloidal suspension at the inlet and flowing the colloidal suspension between the inlet and the outlet in a flow direction; a diffusiophoretic-inducing membrane defining at least part of a plurality of channels extending between the inlet and the outlet; at least one outlet splitter for the plurality of channels; and a channel monitor monitoring a flow of each of the plurality channels.

2. A method of determining the efficacy of a diffusiophoretic water filter comprising:
adding or identifying a marker to a colloidal suspension with first colloidal particles to form a marked colloidal suspension;
diffusiophoretically filtering the marked colloidal suspension into a first stream with a higher concentration of the first colloidal particles and a second stream with a lower concentration of the first colloidal particles; and
monitoring the marker at an outlet.

3. A method for operating a water filtration device comprising a diffusiophoretic water filter having an inlet and an outlet and for receiving a colloidal suspension at the inlet and flowing the colloidal suspension between the inlet and the outlet in a flow direction; a diffusiophoretic-inducing membrane defining at least part of a plurality of channels extending between the inlet and the outlet; the method comprising monitoring for a leak in at least of the channels the water filter.
